(19) United States
(12) Patent Application Publication
(10) Pub. No.: US 2009/0045966 A1
(43) Pub. Date: Feb. 19, 2009

(54) Clothing means having a sensor element for detecting a left position

(76) Inventor: Marko Rocznik, Palo Alto, CA (US)

Correspondence Address: KENYON & KENYON LLP, ONE BROADWAY, NEW YORK, NY, 10004, US

(21) Appl. No.: 12/218,902

(22) Filed: Jul. 18, 2008

(30) Foreign Application Priority Data
Jul. 20, 2007 (DE) 10 2007 034 037.2

(51) Int. Cl. G08B 23/00

(52) U.S. Cl. 340/573.7

(57) ABSTRACT

A clothing arrangement or device having a sensor element for detecting a left position, which includes a housing, at least one position sensor, a chip (IC) having an integrated evaluation circuit, and a current-supply and charge unit, the position sensor being a monoaxial acceleration sensor, the current-supply and charge unit including two high-capacity capacitors, a coil and a diode, and the sensor element being coupled to an external receiver unit. Furthermore, the invention relates to the use of a clothing arrangement or device to avoid the supine hypotensive syndrome in pregnant women.

### FIELD OF THE INVENTION

The present invention relates to a clothing arrangement or device having a sensor element to detect a left position, in particular in order to avoid a supine hypotensive shock syndrome in pregnant women.

### BACKGROUND INFORMATION

In a supine position in late pregnancy, the increasing weight of the baby may cause compression of the large lower hollow vein, the vena cava, by the uterus. This inhibits the return flow of the blood to the heart, so that the placenta has a lower blood flow as well and the unborn child does not receive sufficient oxygen. The result may be hypovolemic shock with a drop in blood pressure and an increased pulse rate; dizziness, tachycardia, dyspnoea and nausea, as well as reduced kidney function and/or central cramping may occur in the process. This is known as vena cava syndrome or supine hypotensive syndrome. In addition, a fetal emergency situation can arise due to the insufficient uterine blood flow and the heart function of the fetus be impaired (CTG change). Furthermore, there is the danger of premature placental detachment.

Pregnant women are therefore advised to use the left lateral position as sleeping position, especially in the last trimester of pregnancy. However, most pregnant women habitually turn into the supine position during sleep and remain in this position until the afore-described symptoms and problems arise due to inadequate circulation by the pressure on the vena cava and the attendant insufficient circulation. These pose a very serious risk to the development of the fetus and the health of the pregnant women herself. The pregnant woman usually wakes up only when the physical symptoms resulting from the inadequate circulation have already occurred.

A few devices for determining the position of a person are as follows.

U.S. Pat. No. 5,914,660 discusses a position-monitoring device to prevent the prone position in infants to prevent sudden infant death (SIDS). This device includes a position-indicating device which is connected to a signal-producing circuit. The position-indicating device generates signals in response to a prone position of the child during sleep. This device may be, for instance, an optical sensor which interacts with a reflexive or other marker that in turn is affixed on the child. If a signal is generated in a prone or lateral position posing a SIDS risk, then it is transmitted to a receiving unit, and an alarm signal is generated.

European Patent EP 1 128 349 A1 relates to a fall detector, which includes a position detector and is used to determine a horizontal or vertical position of the person to be monitored. The fall detector has a housing, which the user may wear on his or her clothing, an impact detector, an electric inclinometer as position detector, and a processor for signal processing and transmission of an alarm signal to an antenna, which in turn forwards the alarm signal to a receiver.

To avoid the attendant considerable risks there is great interest in a device by which the position of a pregnant women is able to be monitored continually and reliably during sleep and by which she is able to be awakened in time if she is not in the recommended left position but in the supine position, in particular.

### SUMMARY OF THE INVENTION

According to the exemplary embodiments and/or exemplary methods of the present invention, a clothing arrangement or device having a sensor element for detecting a left position is provided, which includes a housing, at least one position sensor, a chip (IC) having an integrated evaluation circuit, and a current-supply and charge unit, the position sensor being a monoaxial acceleration sensor, the current-supply and charge unit including two high-capacity capacitors, a coil and a diode, and the sensor element being assigned to an external receiver unit.

According to the exemplary embodiments and/or exemplary methods of the present invention, the monoaxial acceleration sensor measures a sleeping position, i.e., the position of the pregnant person to be monitored, relative to the gravitational field of the earth. The signal detection as well as the evaluation of the signals from the sensor and their transmission to the receiver may be controlled by the chip. The chip is able to measure the acceleration at variable, greater time intervals, e.g., 1×/sec. On this basis the chip may calculate whether the pregnant person is in a left lateral position. A faulty position, i.e., a deviation from the recommended left position, especially a supine position, can be transmitted in a wireless manner by an alarm signal to the associated external receiver unit. According to the exemplary embodiments and/or exemplary methods of the present invention, the external receiver unit may receive the alarm signal from the sensor element and trigger a wakeup signal for the pregnant woman. As a result, she can advantageously correct the occurred faulty position very rapidly, so that the supine hypotensive syndrome and the attendant risks and consequences are able to be avoided.

The high-capacitance capacitors in the embodiment according to the present invention are able to be charged extremely quickly (<1 sec). In comparison with the use of batteries or accumulators, the use of the high-capacitance capacitors, a coil and the diode has the additional advantage that such a current-supply unit makes no further demands on the sealing requirements of the housing as the use of batteries would for exchange purposes, or the use of accumulators would for charging purposes. The charge operation may be controlled by the chip.

In addition, a power-conserving circuit is able to ensure sufficient operating time, such as approximately 24 hours. Furthermore, the capacitors can simultaneously be used as dipole antenna so that the chip may have only two pins via which is receives its supply voltage and may transmit a signal. The use of an additional external antenna for transmitting the signals is therefore no longer required.

The combination of a coil, the capacitors, and a diode as current-supply and charge unit according to the present invention advantageously constitutes a self-securing circuit system which is protected against reverse polarity.

In a further development of the exemplary embodiments and/or exemplary methods of the present invention, a wireless signal may be transmitted to the external receiver unit in the event of an alarm, and the receiver unit is able to generate an acoustic, tactile and/or optical wakeup signal. For example, the receiver unit may be installed in a known alarm clock, which usually emits an acoustic wakeup signal. As an alternative, the receiver unit may also be accommodated in a wrist band and generate a vibrating alarm.

In one exemplary embodiment, the signal detection, the signal analysis, and the evaluation of the position may be implemented within the sensor element. A deviation from the specified left lateral position is thus able to be detected in an especially rapid manner and an alarm state be detected. This provides short signal and current paths. If the alarm case occurs, then the sensor element is able to transmit the detected data to the receiver very quickly by wireless transmission at a low radio output. In an advantageous manner, there is also no continuing radio signal burden since data are transmitted to the external receiver only in the case of an alarm. The smaller the distance to the receiver, the lower the required transmitting power may be. The receiver could be installed in an alarm clock, for example, which normally is placed next to the bed. Furthermore, if it is placed on the left side of the bed, then the recommended left-sided sleeping position may even be present immediately after the pregnant woman has deactivated the wakeup signal.

Furthermore, a receiver unit is provided according to the present invention in which an external voltage supply for the current-supply and charge unit of the sensor element may be integrated. This advantageously dispenses with a further additional charge station for the sensor element.

In another exemplary embodiment, the housing may be formed from a casting compound. Casting compounds as they are known for encapsulating ICs, for example, may be used for this purpose. This protects and stabilizes the employed components of the sensor element, e.g., the chip, in an especially satisfactory manner.

In one exemplary embodiment of the present invention, the form of the housing may constitute the final external form of the clothing arrangement or device. This clothing arrangement or device may be a clothing button. This button may be situated directly on or inside the clothing, e.g., sewn on, or be applied using a snap fastener mechanism. The clothing button may be provided from the outset or may also be affixed later on. Due to the advantageous casting-compound housing and/or the self-securing and reverse-polarity-protected circuit system, such a clothing button according to the present invention may be laundered together with the clothing without any problems and need not be removed and then reattached. Furthermore, such a clothing button may advantageously be produced in large lot numbers according to industry standards. In addition, the clothing arrangement or device according to the present invention including the sensor element does not require either direct skin contact or wiring to detect the left position.

Furthermore, the exemplary embodiments and/or exemplary methods of the present invention relates to the use of a clothing arrangement or device according to the present invention to avoid the supine hypotensive syndrome in pregnant women. The position of a pregnant person is thus advantageously able to be monitored continuously and reliably during sleep and the person be roused early enough if she is not in the recommended left lateral position but in a risky supine position, in particular.

The exemplary embodiments and/or exemplary methods of the present invention also relates to the use of a monoaxial acceleration sensor to produce a device for avoiding a supine hypotensive syndrome in a pregnant person. Such a device may, for instance, be a clothing button having a sensor element according to the previously described embodiments and providing the attendant advantages.

The exemplary embodiments and/or exemplary methods of the present invention is described in greater detail in the following text by way of example with the aid of one variant of an embodiment in conjunction with the drawings without being limited thereto.

### BRIEF DESCRIPTION OF THE DRAWINGS

FIG. 1 shows a plan view of a clothing arrangement or device including a sensor element according to the present invention shown with a housing that is open on top.

FIG. 2 shows a circuit diagram regarding the specific embodiment in FIG. 1.

### DETAILED DESCRIPTION

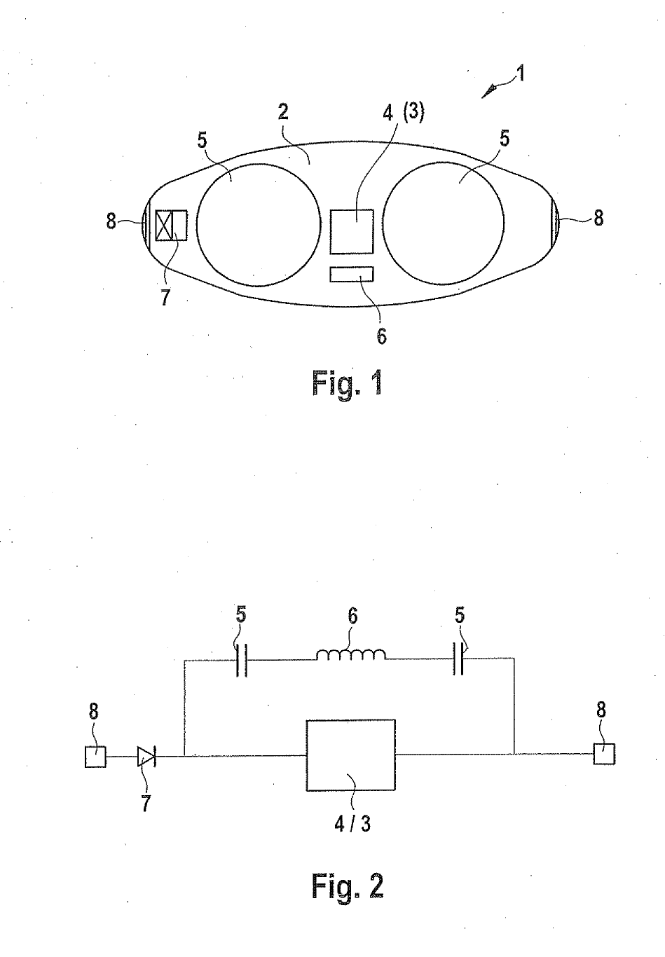

FIG. 1 shows a plan view of a clothing arrangement or device 1 according to the exemplary embodiments and/or exemplary methods of the present invention, which includes a sensor element to detect a left position, in a representation with a housing 2 that is open on top. Housing 2 has a longitudinal form, and may be produced from a casting compound, which is able to protect and support the components inside. In an exemplary manner, the final outer form of clothing arrangement or device 1 is embodied as clothing button, which simultaneously forms housing 2. The outer form of housing 2 may also be variably adapted to different requirements. The clothing arrangement or device includes as position sensor 3 a micromechanical, monoaxial acceleration sensor, which records the acceleration values, and a chip 4 provided with an evaluation circuit. Acceleration sensor 3 may be disposed on chip 4. A combination made up of two capacitors 5, a coil 6, and a diode 7 may be used as current-supply and charge unit. In addition, the housing may include charge terminals 8 at opposite sides, via which capacitors 5 may be recharged by an external charge device. Capacitors 5 may be high-capacitance capacitors having low stray current, which may be DC-coupled. Such a current-supply and charge unit has the advantage that it may be recharged especially rapidly, and constitutes a self-securing and reverse-polarity protected system in addition. The two capacitors 5 may form a dipole. Coil 6 may be used for the high-frequency decoupling of the capacitors, in particular, and thereby prevent short-circuiting of the dipole formed by capacitors 5. In an advantageous manner, capacitors 5 may simultaneously be used as dipole antenna so that chip 4 may have only two pins via which it receives its supply voltage and is able to transmit signals. In this way an additional external antenna for the signal transmission may advantageously be dispensed with. Chip 4 may be what is known as an ASIC (application-specific integrated circuit) having a circuit in which an evaluation algorithm for the position determination is stored and running. This may be implemented both with the aid of a CPU or be permanently integrated directly in the logic. Chip 4 (ASIC) constitutes the intelligent part of the system. Chip 4 may be made up of a current-conserving analog front end, which, under the control of a signal-processing unit, is switched on only for the measurement. Micromechanical acceleration sensor 3 picks up the acceleration values and transmits these signals to chip 4. Since the signal processing and calculation of the measured values of the assumed position takes place digitally, an analog/digital converter may be provided on chip 4. In addition, a digital/analog converter may be supplied as well.

FIG. 2 shows a block diagram of the sensor element of the specific embodiment in FIG. 1 having two charge terminals 8 on housing 2 and a combination of two capacitors 5, a coil 6, and a diode 7 as current-supply and charge unit, as well as a chip 4 having an integrated monoaxial acceleration sensor 3 as position sensor.

In summary, the exemplary embodiments and/or exemplary methods of the present invention provides an arrangement or device that includes a clothing arrangement or device having a sensor element for detecting a left position, which has a simple and cost-effective structure and allows the evaluation of the assumed position and a reliable transmission of the signals to an associated receiver unit to be implemented in a wireless manner. Furthermore, the sensor according to the present invention includes an especially advantageous and reliable current- and charge unit. In addition, the sensor according to the present invention makes it possible to reliably prevent a supine hypotensive syndrome in pregnant women.

What is claimed is:

1. A clothing device comprising:
a sensor element for detecting a left position, including a housing, at least one position sensor, a chip having an integrated evaluation circuit, and a current-supply and charge unit;
wherein the sensor element is a monoaxial acceleration sensor, the current-supply and charge unit includes two high-capacitance capacitors, a coil, and a diode, and the sensor element is assigned to an external receiver unit.

2. The clothing device of claim 1, wherein signal acquisition, signal analysis, and evaluation of the position is performed inside the sensor element.

3. The clothing device of claim 1, wherein, for a detected deviation from the left position, a radio signal is transmitted to the external receiver unit, and the receiver unit generates at least one of an acoustic alarm signal, a tactile alarm signal, and an optical alarm signal.

4. The clothing device of claim 1, wherein an external voltage supply for the current-supply and charge unit of the sensor element is integrated in the receiver unit.

5. The clothing device of claim 1, wherein the housing is made of a casting compound.

6. The clothing device of claim 1, wherein a form of the housing constitutes a final outer form of the clothing device.

7. The clothing device of claim 6, wherein the housing has a button shape.

8. A clothing device to avoid a supine hypotensive syndrome in pregnant women, comprising:
a sensor element for detecting a left position, including a housing, at least one position sensor, a chip having an integrated evaluation circuit, and a current-supply and charge unit;
wherein the sensor element is a monoaxial acceleration sensor, the current-supply and charge unit includes two high-capacitance capacitors, a coil, and a diode, and the sensor element is assigned to an external receiver unit.

9. A monoaxial acceleration sensor arrangement for use in a device for avoiding a supine hypotensive syndrome in pregnant women, comprising:
a monoaxial acceleration sensor arrangement for detecting a left position;
wherein the device includes the sensor arrangement for detecting the left position, and the sensor arrangement includes a housing, at least one position sensor, a chip having an integrated evaluation circuit, and a current-supply and charge unit, and
wherein the current-supply and charge unit includes two high-capacitance capacitors, a coil, and a diode, and the sensor arrangement is assignable to an external receiver unit.
